(19) United States
(12) Patent Application Publication
(10) Pub. No.: US 2024/0303584 A1
(43) Pub. Date: Sep. 12, 2024

(54) AUTOMATED LOGISTICS TRANSSHIPMENT MANAGEMENT SYSTEM

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,730

(22) Filed: Mar. 7, 2023

(51) Int. Cl. G06Q 10/0833; G06Q 10/0875

(52) U.S. Cl. CPC G06Q 10/0833; G06Q 10/0875

(57) ABSTRACT

An automated logistics transshipment management system is provided. The automated logistics transshipment management system includes a login module, for a user to login; a customer module, communicated with the login module and generating an requirement for checking cargo shipping information; a shipping progress tracking module, communicated with the customer module and generating a progress checking signal according to the requirement for checking cargo shipping information, and the shipping progress tracking module has a shipping information confirmation module; a notification module, communicated with the shipping progress tracking module, to receive the progress checking signal and send a notification signal; a cargo arrival module, communicated with the notification module to receive the notification signal and generating a customs declaration information confirmation signal; and an report module, communicated with the cargo arrival module to receive the customs declaration information confirmation signal and generating a report signal to the customer module.

### BACKGROUND OF THE INVENTION

### 1. Field of the Invention

The present disclosure relates to a technical field of international cargo transportation, and more particularly, to an automated logistics transshipment management system applied to customers.

### 2. Descriptions of Related Art

Maritime transport, also known as international ocean cargo transportation, is the most important transportation in international logistics. It refers to a way to transport goods via waterways between ports in different countries and regions and is currently the most widely used method in international cargo transportation.

However, the application level of the existing international freight forwarding logistics industry is generally low. For shipping agents, some are basically using EXCEL, WORD, and other software for manual recording. This manual record management is not only a heavy workload but also has poor standardization and is easy to cause confusion in management. Many departments are involved in the shipping logistics business, and it is often necessary to file and receive information to/from banks, customs, border management, government inspection and quarantine departments, and insurance companies. Further, the information is highly repetitive, which seriously delays the operation efficiency.

Moreover, the current manual document management method makes it difficult to carry out effective tracking, early warning, and statistics of goods. Not only that, this manual document management method has low flexibility and poor stability, and it is difficult to expand and modify functions according to the development of the ship logistics industry. It cannot flexibly manage and change projects. The current management method of manual document records is mainly based on paper documents for information storage, which is not convenient for data sharing, and it is difficult to meet the needs of real-time query, and it is difficult to track and query each business in real-time.

In addition, the known methods of shipping logistics agencies are mostly using paper, email, telephone, SMS, etc., to complete the export-related ship booking and customs declaration operations. For example, the shipping company sends the booking information to the freight forwarding company using paper mail, mail, telephone, SMS, etc. The freight forwarding company then sends the ordering information back to the customer through aper mail, mail, telephone, SMS, etc., and asks the customer to send back the additional information required by the shipping company and customs. After receiving the information, the freight forwarding company sends the information to the shipping company or customs by paper mail, mail, telephone, SMS, etc., to complete the export-related paperwork. Afterward, the freight forwarding company arranges the truck to pick up and deliver the goods by email, telephone, SMS, etc. This method of operation is not only inefficient, time-consuming, and labor-intensive but also seriously affects the efficiency of data processing and transfer.

### SUMMARY OF THE INVENTION

The present disclosure provides an automated logistics transshipment management system, in order to provide the customer to check the current progress of cargo delivery through this system at any time to achieve real-time tracking and digital delivery information related to cargo shipping, as well as improve the conventional international freight forwarding operation process that requires to be contacted by mail, email, telephone, SMS, etc., and the disadvantages of cumbersome processes such as repeated transmission, collection, and confirmation in each department.

In order to achieve the objective mentioned above, the present disclosure provides an automated logistics transshipment management system, including a login module, a customer module, a shipping progress tracking module, a notification module, a cargo arrival module and a report module. The login module is used for a user to log in. The customer module is communicated with the login module and generates a requirement for checking cargo shipping information; The shipping progress tracking module is communicated with the client module and generates a progress checking signal according to the requirement for checking cargo shipping information, and the shipping progress tracking module has a shipping information confirmation module; The notification module, communicated with the shipping progress tracking module to receive the progress checking signal and transmits a notification signal; The cargo arrival module is communicated with the notification module to receive the notification signal and generates (transmits) a customs declaration information confirmation signal. The report module is communicated with the cargo arrival module to receive the customs declaration information confirmation signal and transmits a report signal to the customer module.

In certain embodiments, the automated logistics transshipment management system of the present disclosure further includes a communication interface module bidirectional communication connected between the customer module and a shipper module.

In certain embodiments, the shipping information confirmation module includes a bill of lading number checking information, a total number of goods confirmation information, a total weight confirmation information, a voyage No. confirmation information, a shipment date confirmation information, an arrival date confirmation information and a cargo arrival confirmation information.

In certain embodiments, the bill of lading number checking information is generated according to the content of the goods, the ship's route and shipping schedule, the total number of goods confirmation information is generated according to the number of pieces of consignment, the total weight confirmation information is generated according to the weight of the consignment, the voyage No. confirmation information is generated according to the ship's export, the shipment date confirmation information is generated according to the shipping schedule, and the arrival date confirmation information is generated according to the shipping schedule.

### BRIEF DESCRIPTION OF THE DRAWINGS

The described embodiments may be better understood by reference to the following description and the accompanying drawings in which:

FIG. 1 is a schematic view of modules of one embodiment the automated logistics transshipment management system of the present disclosure.

FIG. 2 is a schematic view of modules of another embodiment of the automated logistics transshipment management system of the present disclosure.

FIG. 3 is a schematic view of a shipping information confirmation module of the automated logistics transshipment management system of the present disclosure.

FIG. 4 is a schematic view of a customs declaration information confirmation signal of the automated logistics transshipment management system of the present disclosure.

### DETAILED DESCRIPTION OF THE PREFERRED EMBODIMENTS

The present disclosure is more particularly described in the drawings and following examples that are intended as illustrative only. It is to be understood that these embodiments are exemplary implementations and are not to be construed as limiting the scope of the present disclosure in any way. Further modifications to the disclosed embodiments, as well as other embodiments, are also included within the scope of the appended claims. Regarding the drawings, the relative proportions and ratios of elements in the drawings may be exaggerated or diminished in size for the sake of clarity and convenience. Such arbitrary proportions are only illustrative and not limiting to the scale.

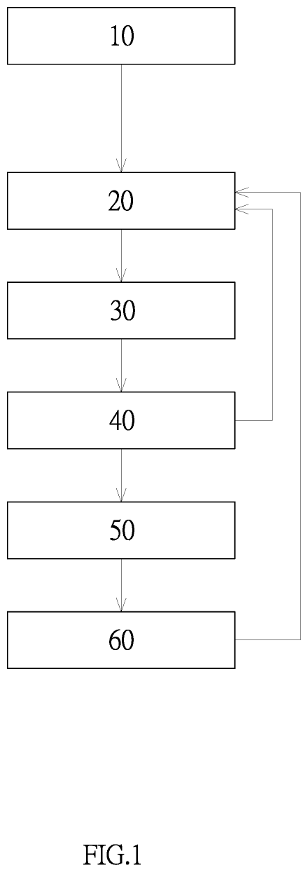

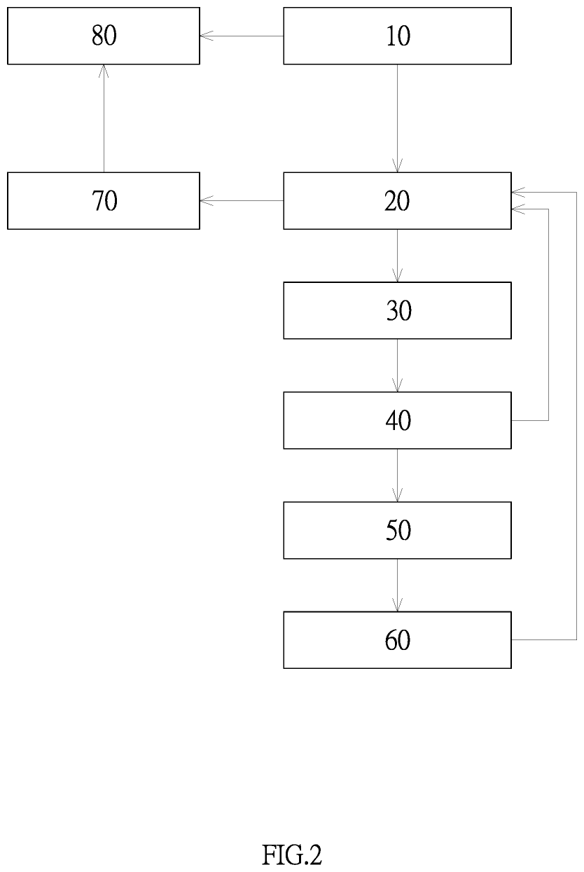

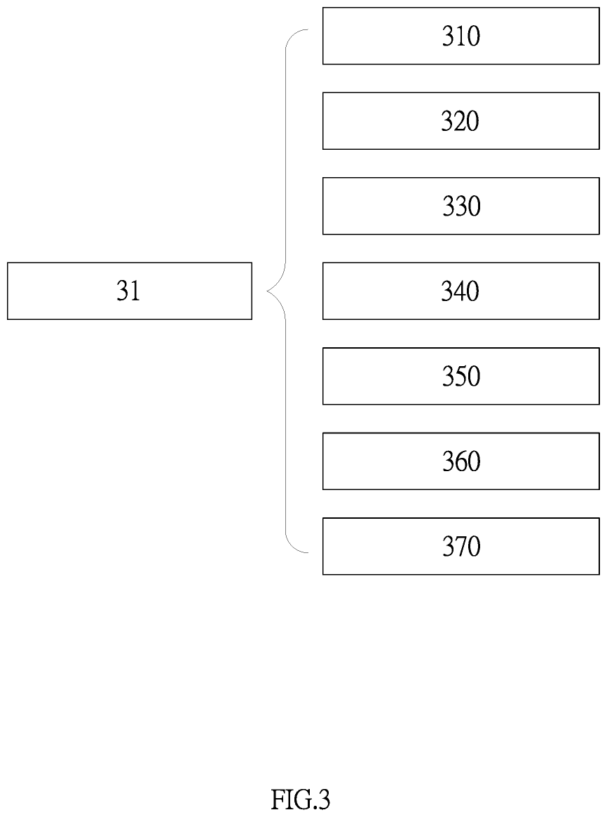

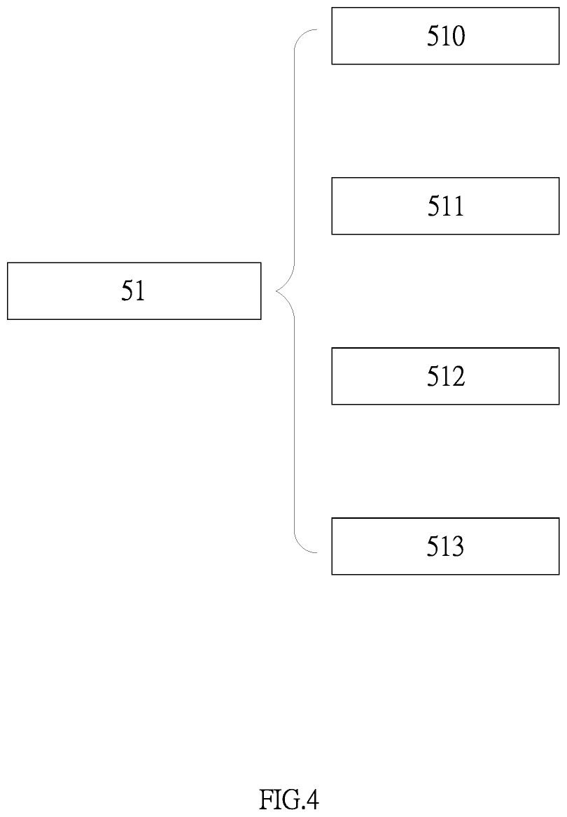

Referring to FIGS. 1-4, the present disclosure provides an automated logistics transshipment management system for customers to check the current progress of cargo delivery at any time. The automated logistics transshipment management system includes a login module 10, a customer module 20, a shipping progress tracking module 30, a notification module 40, a cargo arrival module 50 and a report module 60. The login module 10 is used for a customer to log in.

The customer module 20 is communicated with the login module 10 and generates a requirement for checking cargo shipping information. The cargo shipping information can be departure information, transshipment port information and arrival information.

The shipping progress tracking module 30 is communicated with the customer module 20 module and generates a progress checking signal according to the requirement for checking cargo shipping information, and the shipping progress tracking module 30 has a shipping information confirmation module 31 and an international cargo contract information confirmation module 31. The progress checking signal is used to check a bill of lading number checking information 310, a total number of goods confirmation information 320, a total weight confirmation information 330, a voyage No. confirmation information 340, a shipment date confirmation information 350, an arrival date confirmation information 360 and a cargo arrival confirmation information 370 of the shipping information confirmation module 31. Further, the bill of lading number checking information 310 is generated according to the content of the goods, the ship's route and the shipping schedule. The total number of goods confirmation information 320 is generated according to the number of pieces of consignment. The total weight confirmation information 330 is generated according to the weight of the consignment. The voyage No. confirmation information 340 is generated according to the ship's export. The shipment date confirmation information 350 is generated according to the shipping schedule. The arrival date confirmation information 360 is generated according to the shipping schedule. The cargo arrival confirmation information 370 is generated according to notifying the consignee when the ship arrives at the port. The international cargo contract information confirmation module 32 is used to confirm whether the information of an international cargo contract is correct. In detail, the international cargo contract is generated after all the information of the shipping information confirmation module 31 is correct. The shipping information confirmation module includes a bill of lading number checking information 310, a total number of goods confirmation information 320, a total weight confirmation information 330, a voyage No. confirmation information 340, a shipment date confirmation information 350, an arrival date confirmation information 360, and a cargo arrival confirmation information 370.

The notification module 40 is communicated with the shipping progress tracking module 30 to receive the progress checking signal and to transmit a notification signal. Specifically, the notification signal includes a normal signal and an abnormal signal. After the shipping progress tracking module 30 confirms the information in the shipping information confirmation module 31 and the international cargo contract information confirmation module 32, if the information is correct, a normal signal will be sent; otherwise, if the information is incorrect, an abnormal signal will be sent. Further, whether it is a normal signal or an abnormal signal, it will be sent back to the customer module 20. If the customer module 20 receives the normal signal, the system will continue to perform subsequent steps; if the customer module 20 receives the abnormal signal, the customer module 20 will re-request a new requirement for checking cargo shipping information to the shipping progress tracking module 30 for checking the correctness of the cargo shipping information. Suppose the information obtained after checking is still wrong. In that case, the notification module 40 will repeatedly send abnormal signals to the customer module 20 and continue to request the requirement for checking cargo shipping information to the shipping progress tracking module 30, until a normal signal is issued by the notification module 40.

The cargo arrival module 50 is communicated with the notification module 40 to receive the normal signal from the notification module 40 and transmit a customs declaration information confirmation signal 51. The customs declaration information confirmation signal 51 includes a departure port information 510, a destination port information 511, an approval information 512 and a trade information 513. The departure port information 510 is used to display departure port name and departure port code, the destination port information 511 is used to display destination port name and destination port code, the approval information 512 is used to display approval number, and the trade information 513 is used to display code according to actual trade classification of goods.

The report module 60 is communicated with the cargo arrival module 50 to receive the customs declaration information confirmation signal 51 and transmits a report signal to the customer module 20.

The communication interface module 70 is bidirectional communication connected between the customer module 20 and a shipper module 80. Through the communication interface module 70, the customer and the shipper can communicate with each other. To further illustrate, after the cargo arrival module 50 transmits the customs declaration information confirmation signal 51 to the report module 60, the report module 60 will transmit the report signal to the customer module 20. At this time, the customer module 20 can transmit the received report signal to the shipper module 80 through the communication interface module 70, so that both the customer module 20 and the shipper module 80 can simultaneously receive notification that the cargo has arrived at the destination port.

In conclusion, the automated logistics transshipment management system of the present disclosure includes the customer module 20, the shipping progress tracking module 30, the notification module 40, a cargo arrival module 50, the report module 60 and the communication interface module 70. Through the intelligent modules combination that can automatically generate various cargo transshipment information, the customer and the shipping agency can check the progress of the current cargo delivery through this system at any time, so as to achieve real-time tracking and digitization of delivery information. It can be seen that the automated logistics transshipment management system of the present disclosure has indeed improved the conventional international freight forwarding operation process and overcome the disadvantage of using paper mail, e-mail, telephone, and SMS, and complicated process with repeatedly transmitting, collecting, and confirming.

What is claimed is:

1. An automated logistics transshipment management system, comprising:
a login module, for a user to log in;
a customer module, communicated with the login module and generating a requirement for checking cargo shipping information;
a shipping progress tracking module, communicated with the customer module and generating a progress checking signal according to the requirement for checking cargo shipping information, and the shipping progress tracking module has a shipping information confirmation module;
a notification module, communicated with the shipping progress tracking module to receive the progress checking signal and send a notification signal;
a cargo arrival module, communicated with the notification module to receive the notification signal and generating a customs declaration information confirmation signal; and
a report module, communicated with the cargo arrival module to receive the customs declaration information confirmation signal and generating a report signal to the customer module.

2. The automated logistics transshipment management system according to claim 1, further including a communication interface module, bidirectional communication connected between the customer module and a shipper module.

3. The automated logistics transshipment management system according to claim 1, wherein the shipping progress tracking module includes an international cargo contract information confirmation module.

4. The automated logistics transshipment management system according to claim 1, wherein the shipping information confirmation module includes a bill of lading number checking information, a total number of goods confirmation information, a total weight confirmation information, a voyage No. confirmation information, a shipment date confirmation information, an arrival date confirmation information and a cargo arrival confirmation information.

5. The automated logistics transshipment management system according to claim 4, wherein the bill of lading number checking information is generated according to the content of the goods, the ship's route and shipping schedule, the total number of goods confirmation information is generated according to the number of pieces of consignment, the total weight confirmation information is generated according to the weight of consignment, the voyage No. confirmation information is generated according to the ship's export, the shipment date confirmation information is generated according to the shipping schedule, and the arrival date confirmation information is generated according to the shipping schedule.

6. The automated logistics transshipment management system according to claim 1, wherein the customs declaration information confirmation signal includes a departure port information, a destination port information, an approval information and a trade information.

7. The automated logistics transshipment management system according to claim 6, wherein the departure port information is used to display departure port name and departure port code, the destination port information is used to display destination port name and destination port code, the approval information is used to display approval number, and the trade information is used to display code according to actual trade classification of goods.

8. The automated logistics transshipment management system according to claim 1, wherein the requirement for checking cargo shipping information is a departure information.

9. The automated logistics transshipment management system according to claim 1, wherein the requirement for checking cargo shipping information is an arrival information.

10. The automated logistics transshipment management system according to claim 1, wherein the requirement for checking cargo shipping information is a transshipment port information.
